(19) United States
(12) Patent Application Publication
(10) Pub. No.: US 2007/0251135 A1
(43) Pub. Date: Nov. 1, 2007

(54) Universal Motion Master #2

(76) Inventors: Robert Alan Watlov, Rogers, MN (US); Mark Weber, Dawson, MN (US)

Correspondence Address: WILSON DANIEL SWAYZE, JR., 3804 CLEARWATER CT., PLANO, TX, 75025, US

(21) Appl. No.: 11/739,707

(22) Filed: Apr. 25, 2007

Related U.S. Application Data
(60) Provisional application No. 60/794,753, filed on Apr. 25, 2006.

(51) Int. Cl. A01M 31/06

(52) U.S. Cl. 43/3

(57) ABSTRACT

A duck stand for attachment to a duck decoy includes an attachment member to attach the duck stand to the duck decoy. A bias member to variably bias the attachment member and a stand mounting member to allow the duck stand to be mounted in the ground. The duck stand includes a collar member to change the bias of the bias member, a spring, a mounting member to connect to the attachment member, a top sleeve member to connect to the mounting member, a bottom sleeve member to attach to the collar member and a stake member to cooperate with the bottom sleeve member, the collar member and the top sleeve member.

### PRIORITY

The present application claims priority under 35 USC section 119 based on provisional application Ser. No. 60/794, 753 which was filed on Apr. 25, 2006.

### FIELD OF THE INVENTION

The present invention relates to devices associated with duck hunting, and more particularly to a device to provide motion to a duck decoy.

### BACKGROUND OF THE INVENTION

Hunters often use decoys to attract prey into an area which the prey would consider safe. Water fowl decoys are well known which mimic the shape and coloration of a water fowl. Various types of decoys are used on land while other types of decoys are used to float in water. The floating decoys are placed by the hunter in water to which the ducks are attracted. The decoys typically have a fowl shaped body made of a buoyant material using a variety of methods. Early decoys were carved from wood which often became water logged and did not last long. Later, decoys were carved from cork. While the cork decoys were more buoyant and lighter to carry, the cork decoys also degraded over time. Recently, most decoys are produced from blow-molded plastic. The decoys are inexpensive and very light weight. However, these decoys are easily damaged and must be replaced often.

Decoys have also been made from styrofoam with cloth covers. However, these decoys are easily torn and destroyed. Also, decoys have been made from urethane foam which produces a solid foam decoy. The solid foam decoy is, however brittle and therefore subject to breakage. This type of foam decoy does not allow the decoy to have detailed features to more accurately mimic a live water fowl.

### SUMMARY

The Universal Motion Master #2 of the present invention provides a holder for a duck decoy to create lifelike walking and feeding motion in a decoy spread. The Universal Motion Master #2 can be attached to a wide range of shell decoys or full-bodied decoys. While the present invention refers to duck decoys, the present invention can be used for any decoy including duck, goose, turkey, crow, big-game and the like to create motion. The Universal Motion Master #2 is simple to install and can be adapted to the pivot point to each style and brand of decoy. The Universal Motion Master #2 can be activated by the wind, manually or by a motor and prevents over exaggerated motion and prevents the unwanted 360° spinning motion of the decoyed around its pivot point even in heavy wind.

A duck stand for attachment to a duck decoy includes an attachment member to attach the duck stand to the duck decoy. A bias member to variably bias the attachment member and a stand mounting member to allow the duck stand to be mounted in the ground.

The duck stand includes a collar member to change the bias of the bias member, which may be a spring, a mounting member to connect to the attachment member, a top sleeve member to connect to the mounting member, a bottom sleeve member to attach to the collar member and a stake member to cooperate with the bottom sleeve member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the Universal Motion Master #2 of the present invention;

FIG. 2 illustrates an exploded view of the Universal Motion Master #2 of the present invention;

FIG. 3 illustrates a side view of the Universal Motion Master #2 with a shell decoy;

FIG. 4 illustrates a sectional view of the Universal Motion Master #2 with the shell decoy.

### DETAILED DESCRIPTION

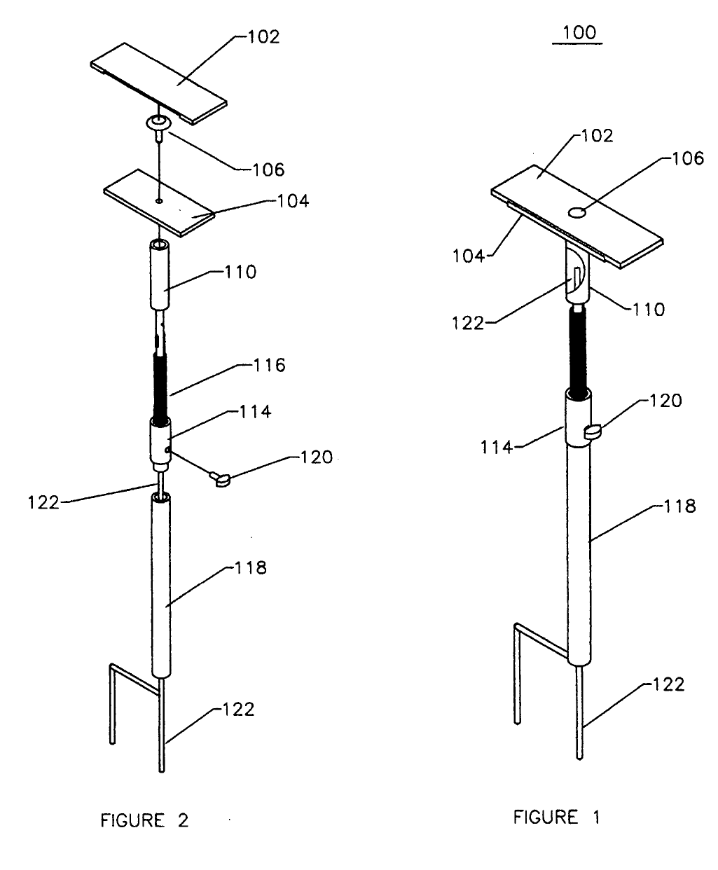

FIG. 1 illustrates the Universal Motion Master #2 or duck stand 100 to mount a duck decoy which may be either a shell or solid duck decoy. The duck stand 100 includes an attachment member 102 and a mounting member 104 to mount the attachment member 102; the mounting member 104 may be a rectangular plate. The mounting member 104 may be formed from rigid material to support the duck decoy. The attachment member 102 may be formed from Velcro or other suitable fastening apparatus in order to connect the duck stand 100 to the duck decoy. The attachment member 102 is positioned on the mounting member 104 which is connected to the top sleeve member 110 by the first fastening member 106 which may be an attachment screw or other suitable apparatus or member 104 and member 110 may be glued together or member 104 and member 110 may be one molded piece. The top sleeve member 110 may be a hollow cylinder or tube to be positioned at one end of the stake member 122 as seen in the cut out of FIG. 1 and may be formed from rigid material. FIG. 1 additionally illustrates a biasing member 116 which may be a spring and which is positioned over the stake member 122. The biasing member 116 biases the top sleeve member 110 to provide lifelike motion to the duck decoy mounted on the attachment member 102. One end of the biasing member 116 is connected to the collar member 114 which travels along the stake member 122 to control the amount of biasing supplied by the biasing member 116. The collar member 114 includes a second fastening member 120 which may be a threaded bolt which is threaded into a threaded aperture of the collar member 114 to engage the stake member 122 and to hold the collar member 114 in position and to hold the biasing member 116. The collar member 114 can be moved along the stake member 122 to control the biasing or spring tension of the biasing member 116. The duck stand 100 may include a bottom sleeve member 118 which can be positioned on the stake member 122 to cooperate with the collar member 114 and which may be a hollow cylinder. The bottom sleeve is a cosmetic piece that is not necessary for the functionality of the invention. However, the bottom sleeve may be painted a color to match the natural coloring of the species that the decoy is intended to mimic.

The duck stand 100 additionally includes a stand mounting feature of the stake member 122 for mounting the duck stand 100 in the ground, and the stand mounting feature of the stake member 122 which extends out of the bottom sleeve member 118. The stand mounting of the stake member 112 is shown as an inverted U shaped device, but could take on many different forms as long as it securely anchors the duck stand in the ground.

One end of the stake member 122 extends into the top sleeve member 110. The distance that the end of the stake member 122 extends into the top sleeve member 110 determines the amount of movement between the top sleeve member 110 and the stake member 122 and correspondingly limits the amount of motion of the decoy. This in conjunction with the biasing member 116 determines how far and how easily the decoy moves. The stake member 122 extends through the biasing member 116 and into the top sleeve member 110 to provide movement both vertically and horizontally when the biasing member 116 is attached.

FIG. 2 illustrates the biasing member 116 connected to the top sleeve member 110 which is connected to the mounting member 104 which is in turn connected to the attachment member 102. The attachment member 102 is to fasten to the duck decoy. The biasing member 116 biases the top sleeve member 110. The collar member 114 moves along the stake member 122 to adjust the amount of biasing the biasing member 116 applies to the top sleeve member 110. The further the collar member 114 is from the top sleeve member 110, the more biased force is applied to the top sleeve member 110. The increased biased force applied to the top sleeve member 110 increases the force such as the wind force needed to move the duck decoy.

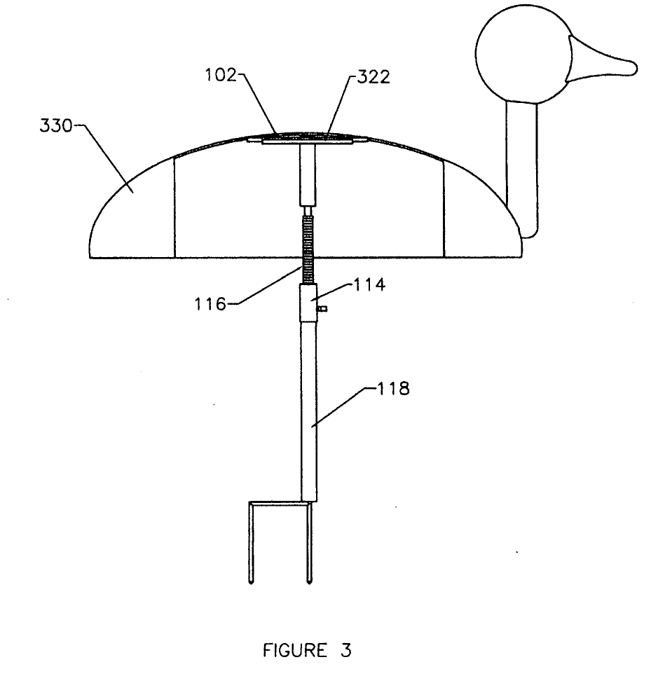

FIG. 3 illustrates a duck decoy 330 which includes a pivot point 322 for mounting an duck stand 100 of the present invention. The attachment member 102 attaches to the duck decoy 330, and the biased member 116 variably biases the top sleeve member 110 to allow the duck decoy 330 to have little movement if the bias is relatively strong and the duck decoy 330 has more movement if the bias is relatively weak.

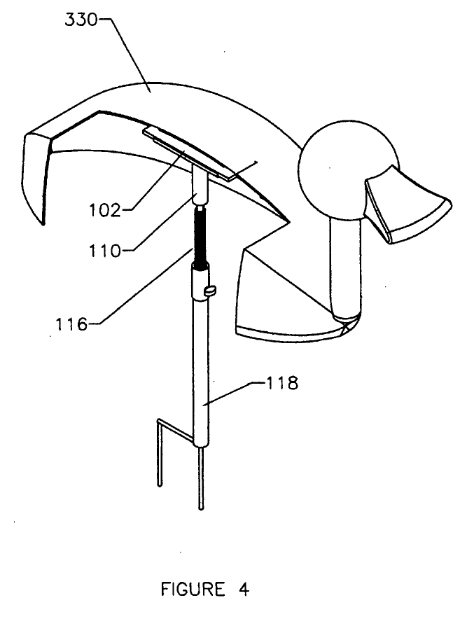

FIG. 4 illustrates the duck decoy 330 and the attachment member 102 for attachment to the duck decoy 330. FIG. 4 additionally illustrates the bias member 116 and the bottom sleeve member 118.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A duck stand for attachment to a duck decoy, comprising:
an attachment member to attach the duck stand to the duck decoy;
a bias member to variably bias the attachment member
a stake member to variably bias the attachment member as the top of the stake member is variably positioned in a top sleeve member; and
a stand mounting member to allow the duck stand to be mounted in the ground.

2) A duck stand for attachment to a duck decoy as in claim 1, wherein the duck stand includes a collar member to change the bias of the bias member.

3) A duck stand for attachment to a duck decoy as in claim 1, wherein the bias member includes a spring.

4) A duck stand for attachment to a duck decoy as in claim 1, wherein the duck stand includes a mounting member to connect to the attachment member.

5) A duck stand for attachment to a duck decoy as in claim 4, wherein the duck stand includes a top sleeve member to connect to the mounting member.

6) A duck stand for attachment to a duck decoy as in claim 5, wherein the duck stand may include a bottom sleeve member to attach to the collar member.

7) A duck stand for attachment to a duck decoy as in claim 6, wherein the duck stand includes a stake member to cooperate with the bottom sleeve member.

8) A duck stand for attachment to a duck decoy as in claim 2, wherein the duck stand includes a stake member to cooperate with the collar member.

9) A duck stand for attachment to a duck decoy as in claim 5, wherein the duck stand includes a stake member to cooperate with the top sleeve member.
